(19) United States
(12) Patent Application Publication
(10) Pub. No.: US 2012/0072877 A1
(43) Pub. Date: Mar. 22, 2012

(54) LAYOUT VERIFICATION APPARATUS AND LAYOUT VERIFICATION METHOD

(76) Inventors: Hideki TAKAHASHI, Yokohama-shi (JP); Tsuyoshi Etoh, Yokohama-shi (JP); Tomohito Kawano, Yokohama-shi (JP); Tatsuya Hiramatsu, Yokohama-shi (JP); Kiyoharu Murakami, Yokohama-shi (JP); Kouji Nakao, Yokohama-shi (JP)

(21) Appl. No.: 13/229,908

(22) Filed: Sep. 12, 2011

(30) Foreign Application Priority Data
Sep. 22, 2010 (JP) 2010-212717

(51) Int. Cl. G06F 17/50

(52) U.S. Cl. 716/112

(57) ABSTRACT

According to one embodiment, a layout verification apparatus includes a design section, a layout creation section, a first verification section and a second verification section. One of the first and second verification sections includes a filter processing section which executes a filter processing of a verification target element to be verified by a mask data used to a manufacture of the semiconductor integrated circuit, and the verification target element to be verified needs an ion implantation. The filter processing section comprises a first logic section which executes an logical AND of the verification target element to be verified, a mask data necessary in order to form the verification target element to be verified, and a data inverted a mask data unnecessary in order to form the verification target element to be verified.

### CROSS-REFERENCE TO RELATED APPLICATIONS

This application is based upon and claims the benefit of priority from prior Japanese Patent Application No. 2010-212717, filed Sep. 22, 2010, the entire contents of which are incorporated herein by reference.

### FIELD

Embodiments described herein relate generally to a layout verification apparatus and a layout verification method.

### BACKGROUND

When designing a semiconductor integrated circuit, a circuit diagram is created first based on specification information, and the layout (design data) of the semiconductor integrated circuit is created based on the circuit diagram. Layout check is then performed to verify whether the layout of the semiconductor integrated circuit has been designed correctly.

### BRIEF DESCRIPTION OF THE DRAWINGS

FIG. 1 is a block diagram showing a layout verification apparatus;

FIGS. 2 and 3 are flowcharts showing the first embodiment;

FIG. 4 is a flowchart showing a filter processing step;

FIG. 5 is a flowchart showing an ion implantation check step;

FIG. 6 is a plan view showing the design data of P-channel FETs;

FIG. 7 is a sectional view showing the device of the P-channel FETs;

FIG. 8 is a plan view showing the design data of N-channel FETs;

FIG. 9 is a sectional view showing the device of the N-channel FETs;

FIG. 10 is a plan view showing the design data of resistance elements;

FIG. 11 is a sectional view showing the device of the resistance elements;

FIG. 12 is a view showing an element extraction step;

FIG. 13 is a view showing a mask data NOT-processing step;

FIG. 14 is a view showing mask data necessary for verification target elements;

FIGS. 15, 16, and 17 are views showing filter processing without any design error;

FIGS. 18 and 19 are views showing filter processing with any design error;

FIGS. 20 and 21 are views showing a comparison verification step;

FIG. 22 is a block diagram showing a layout verification apparatus;

FIG. 23 is a flowchart showing the second embodiment;

FIG. 24 is a flowchart showing a filter processing step;

FIG. 25 is a flowchart showing an ion implantation check step; and

FIG. 26 is a flowchart showing parallel processing of filter processing steps.

### DETAILED DESCRIPTION

In general, according to one embodiment, a layout verification apparatus of a semiconductor integrated circuit, the apparatus comprising: a design section configured to design a circuit diagram based on specification information; a layout creation section configured to create a layout of a semiconductor integrated circuit based on the circuit diagram; a first verification section configured to verify whether an element extracted from the layout of the semiconductor integrated circuit matches the circuit diagram; and a second verification section configured to verify whether the layout of the semiconductor integrated circuit violates a design rule extracted from the specification information, wherein one of the first and second verification sections includes a filter processing section which executes a filter processing of a verification target element to be verified by a mask data used to a manufacture of the semiconductor integrated circuit, and the verification target element to be verified needs an ion implantation, wherein the filter processing section comprises a first logic section which executes an logical AND of the verification target element to be verified, a mask data necessary in order to form the verification target element to be verified, and a data inverted a mask data unnecessary in order to form the verification target element to be verified.

Layout check includes a design rule check (DRC) that verifies whether design data violates a design rule extracted from specification information, and layout-versus-schematic (LVS) that verifies whether elements extracted from design data and connections between them match a circuit diagram. If an error is detected by the layout check, the layout (design data) of the semiconductor integrated circuit is corrected.

The design data correction is repeated until the layout check is passed.

However, when an element extracted from design data requires ion implantation, this layout check cannot verify whether ion implantation can correctly be performed for the element.

More specifically, since forming a semiconductor integrated circuit needs many ion implantation steps, there exist a lot of mask data for the ion implantation. If mask data necessary in order to form an element extracted from design data is correct, but mask data unnecessary for formation of the element contains a design error, the element may undergo unnecessary ion implantation.

In the above-described layout check, when extracting an element by LVS, only design data necessary in order to form the element is used. For this reason, design errors in mask data unnecessary in order to form the element cannot be detected. In a DRC, design errors in mask data cannot be detected as far as design data satisfy the design rule.

Hence, a photo mask is manufactured based on wrong mask data. Consequently, unnecessary ion implantation is performed when manufacturing a semiconductor integrated circuit so that the device characteristics degrade.

This problem is conventionally solved by visually verifying the layout (design data) of the semiconductor integrated circuit after layout check. However, visually verifying for all elements that need ion implantation and all mask data whether unnecessary ion implantation is to be done requires an enormous amount of labor and time, as a matter of course. In addition, there is possibility of human errors in check.

Embodiments will now be described with reference to the accompanying drawings.

### 1. LAYOUT VERIFICATION APPARATUS OF SEMICONDUCTOR INTEGRATED CIRCUIT

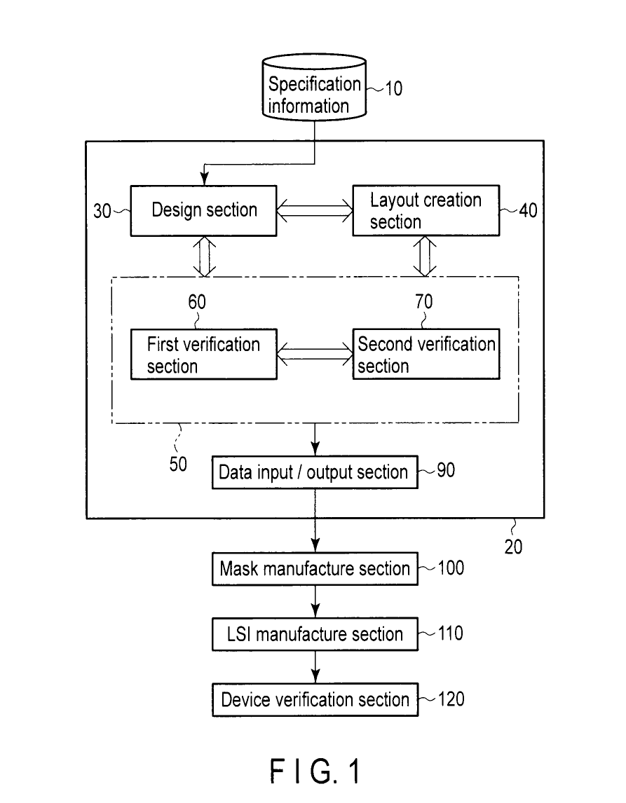

FIG. 1 shows a layout verification apparatus of a semiconductor integrated circuit.

A layout verification apparatus 20 includes a design section 30 that designs a circuit diagram based on specification information 10, and a layout creation section 40 that creates the layout of a semiconductor integrated circuit based on the circuit diagram. When designing a semiconductor integrated circuit, a circuit diagram is created first based on the specification information 10, and the layout (design data) of the semiconductor integrated circuit is created based on the circuit diagram. Layout check is then performed to verify whether the layout of the semiconductor integrated circuit has been designed correctly.

A layout verification section 50 in the layout verification apparatus 20 performs the layout check. The layout verification section 50 includes a first verification section (for example, LVS) 60 that verifies whether elements extracted from the design data and connections between them match the circuit diagram, and a second verification section (for example, a DRC) 70 that verifies whether the design data violates a design rule extracted from the specification information.

If an error is detected by layout check in the layout verification section 50, a data input/output section 90 in the layout verification apparatus 20 outputs error information. The designer corrects the layout (design data) of the semiconductor integrated circuit based on the error information. The design data correction and layout check are repeated until the layout check is passed.

In this embodiment, the layout verification section 50 includes a filter processing section that performs, for a verification target element that requires ion implantation, filter processing by mask data to be used for the semiconductor integrated circuit. The filter processing section may be added newly as one function of the first verification section 60 or the second verification section 70. Alternatively, the filter processing section may be added as a third verification section in the layout verification section 50 independently of the first verification section 60 and the second verification section 70.

Details of the filter processing section will be described later, and only characteristic features will briefly be explained here. The filter processing section includes a first logic section and a second logic section. The first logic section executes a logical AND between a verification target element, mask data necessary in order to form the verification target element, and inverted data of mask data unnecessary in order to form the verification target element. The second logic section determines the presence/absence of an ion implantation area unnecessary for the verification target element by executing a logical exclusive OR between the verification target element before execution of the logical AND and that after execution of the logical AND.

The verification target element and the mask data are represented by binary values (“0”/“1”) that are identical. The mask data shows an area (ion implantation area) to be subjected to ion implantation.

A mask manufacture section 100 manufactures a photo mask based on the mask data. An LSI manufacture section 110 performs photolithography using the photo mask manufactured based on the mask data so as to form a resist mask on a semiconductor device. A device verification section 120 verifies the characteristics of the semiconductor device manufactured by the LSI manufacture section 110.

In this embodiment, the layout verification section 50 includes the filter processing section. For this reason, if unnecessary ion implantation is to be performed for the verification target element, or necessary ion implantation is not to be performed for the verification target element due to a design error in the mask data, the error can be detected quickly and reliably. The filter processing section can also specify the position of the verification target element having the error.

Hence, the designer can quickly and reliably correct the design error based on the verification result output from the layout verification apparatus 20. This allows to shorten the design time.

### 2. OPERATION OF LAYOUT VERIFICATION APPARATUS

The operation (layout verification method) of the layout verification apparatus in FIG. 1 will be explained.

### (1) First Embodiment

First, the design section 30 designs a circuit diagram based on specification information (design step). Next, the layout creation section 40 creates the layout (design data) of a semiconductor integrated circuit based on the circuit diagram (layout creation step).

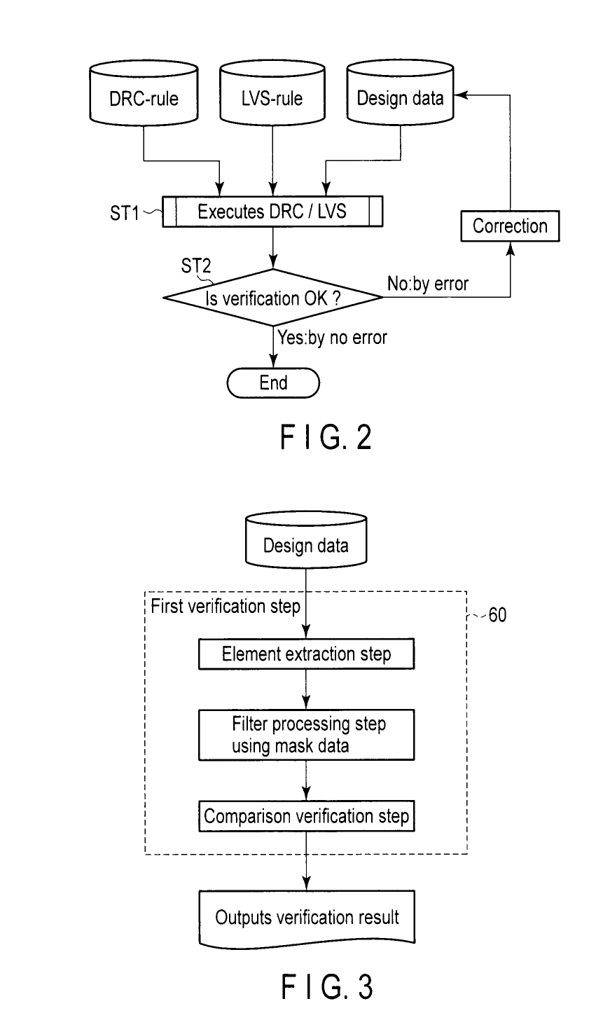

After that, layout check is performed in accordance with the flowchart of FIG. 2 to verify whether the layout of the semiconductor integrated circuit has been designed correctly.

First, a first verification step (LVS) is executed to verify based on the DRC-rule, the LVS-rule, and the design rule whether elements extracted from the design data and connections between them match the circuit diagram. In addition, a second verification step (DRC) is executed to verify whether the design data violates the design rule extracted from the specification information (step ST1).

After that, the layout of the semiconductor integrated circuit is verified (step ST2).

Upon detecting an error in this verification, the designer corrects the layout based on the error information. The design data correction and layout check are repeated until the layout check is passed.

In the first verification step, it is also verified whether an unnecessary ion implantation area exists.

That is, the first verification step includes a filter processing step of performing, for a verification target element extracted in the element extraction step and requiring ion implantation, filter processing by mask data to be used for the semiconductor integrated circuit, and a comparison verification step (LVS step) of performing comparison verification to verify whether the verification target element that has undergone the filter processing step matches the circuit diagram, as shown in the flowchart of FIG. 3. Hence, the layout verification apparatus outputs a verification result reflecting the result of the filter processing step.

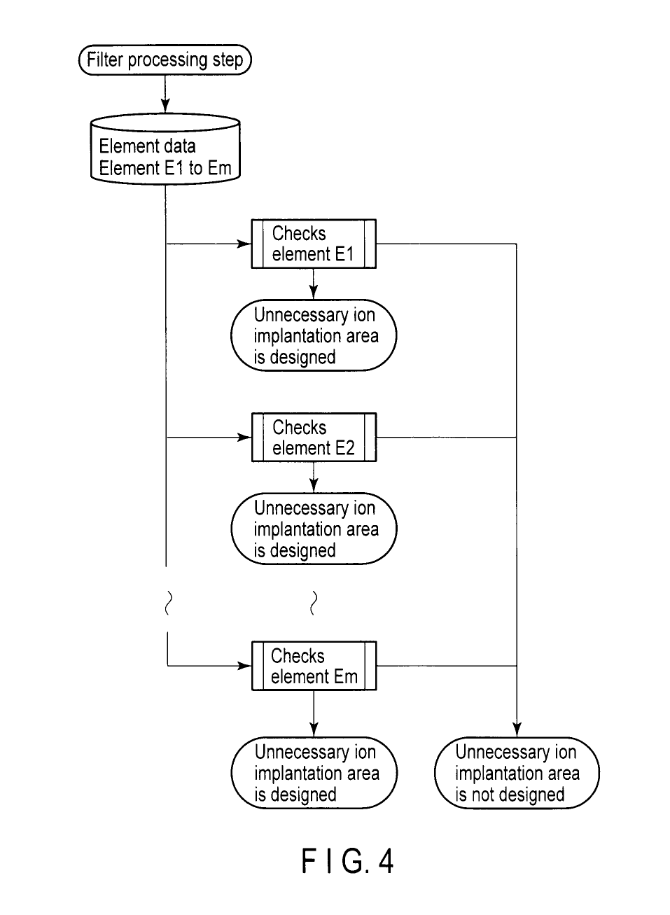

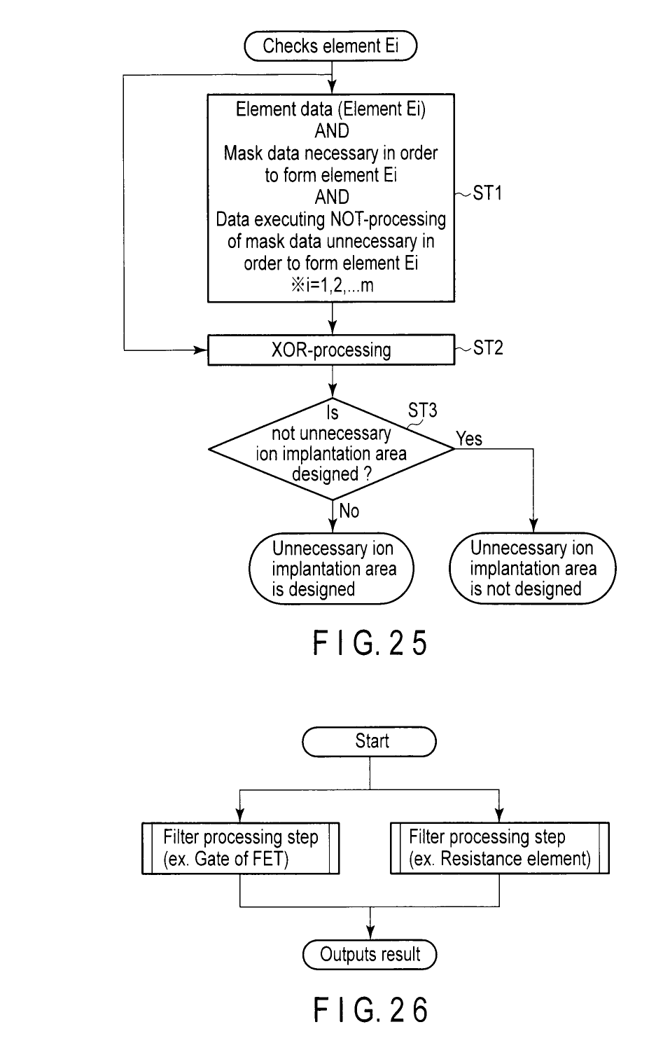

The filter processing step is performed as parallel processing for a plurality of verification target elements of identical type (for example, one of the gate and source/drain of a FET, a resistance element, a capacitance element, and a rectifying element) extracted from the semiconductor integrated circuit, as shown in the flowchart of FIG. 4. Together with this parallel processing, parallel processing may be performed for a plurality of verification target elements of different types extracted from the semiconductor integrated circuit, as shown in the flowchart of FIG. 26.

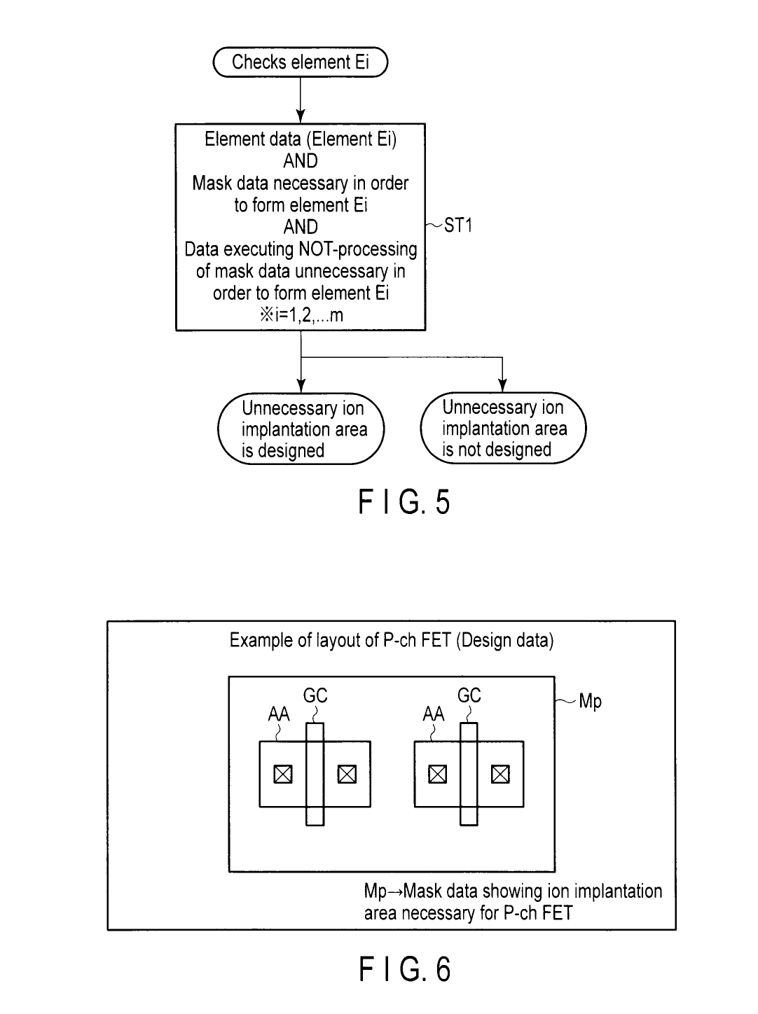

More specifically, the filter processing step includes a first logic step (step ST1) of executing the logical AND between a verification target element (element data) Ei(i=1, 2, . . . , m), mask data necessary in order to form the verification target element Ei, and data executing NOT-processing of mask data unnecessary in order to form the verification target element Ei (inverted data of mask data unnecessary in order to form the verification target element Ei), as shown in the flowchart of FIG. 5.

When the layout of the semiconductor integrated circuit is verified in accordance with the above-described procedure, the presence/absence of an unnecessary/necessary ion implantation area for the verification target element Ei can be determined. This will be described based on the state (image) of the change of design data.

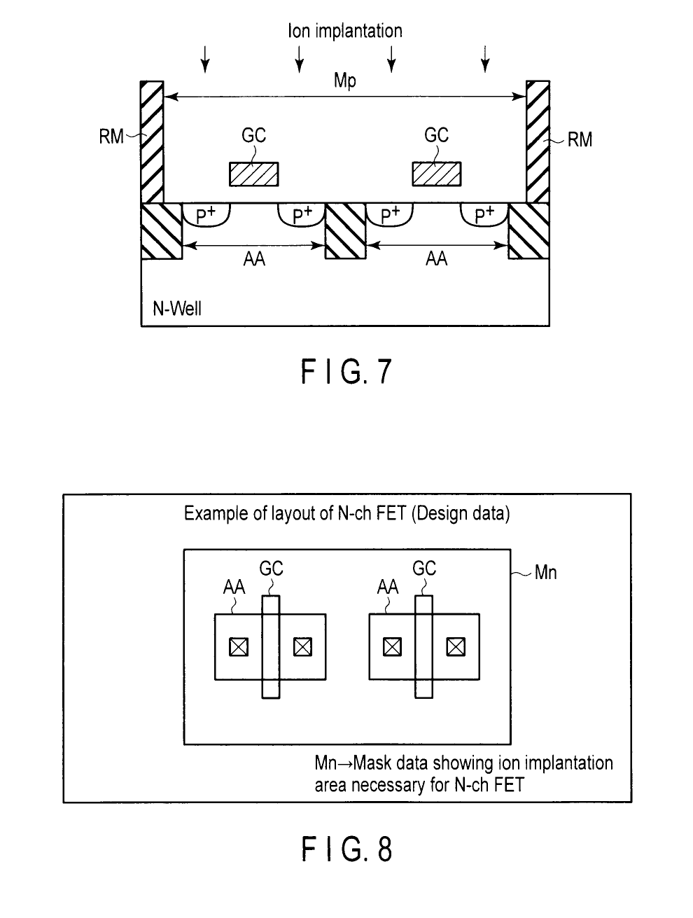

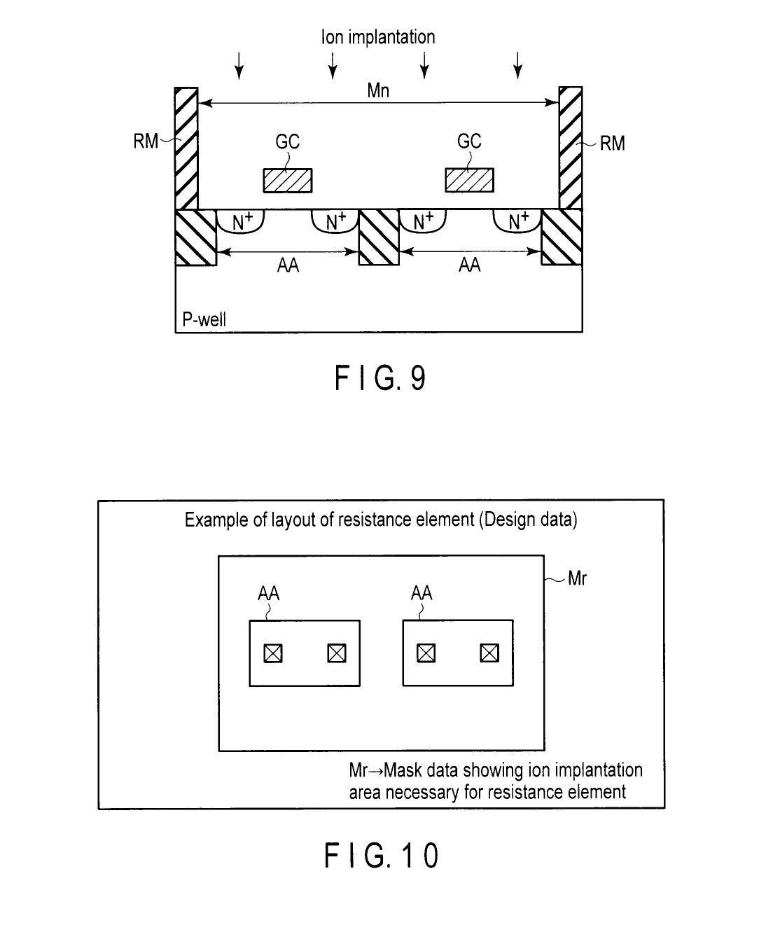

FIG. 6 illustrates an example of the layout (design data) of P-channel FETs. AA indicates an active area; GC, a gate, and Mp, mask data. The mask data Mp shows an area (ion implantation area) to be actually subjected to P-impurity ion implantation when manufacturing a semiconductor device. That is, as shown in FIG. 7, ion implantation to form the P-channel FETs is performed for the ion implantation area shown by the mask data Mp using a resist mask RM as a mask.

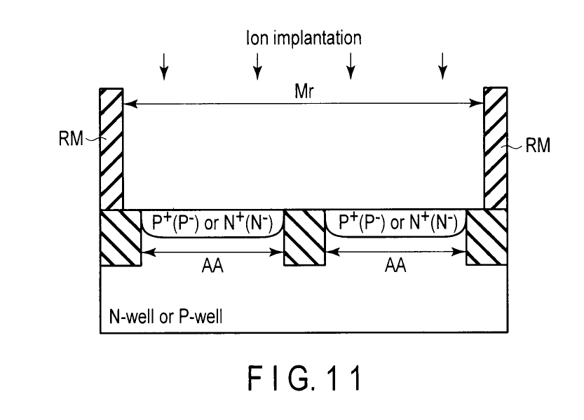

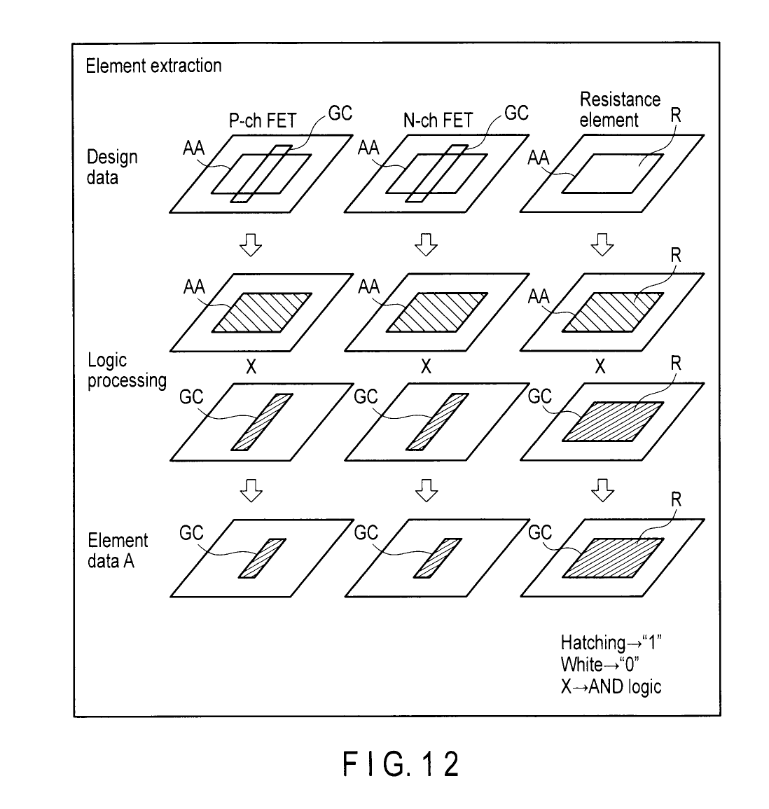

FIG. 8 illustrates an example of the layout (design data) of N-channel FETs. AA indicates an active area; GC, a gate, and Mn, mask data. The mask data Mn shows an area (ion implantation area) to be actually subjected to N-impurity ion implantation when manufacturing a semiconductor device. That is, as shown in FIG. 9, ion implantation to form the N-channel FETs is performed for the ion implantation area shown by the mask data Mn using the resist mask RM as a mask.

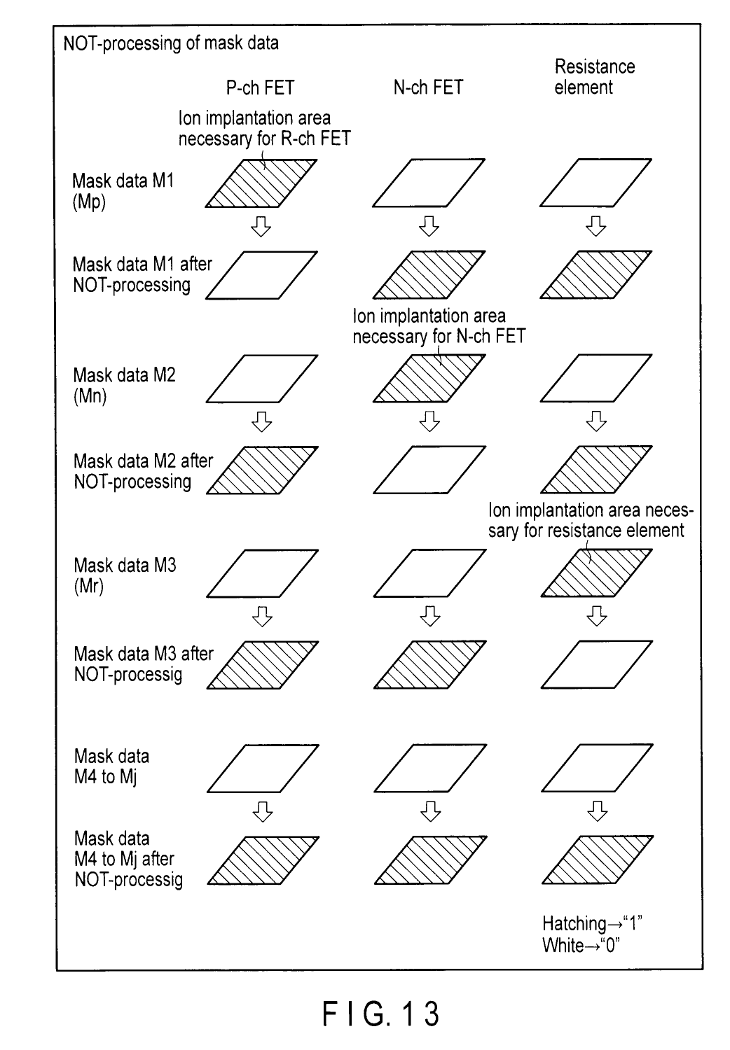

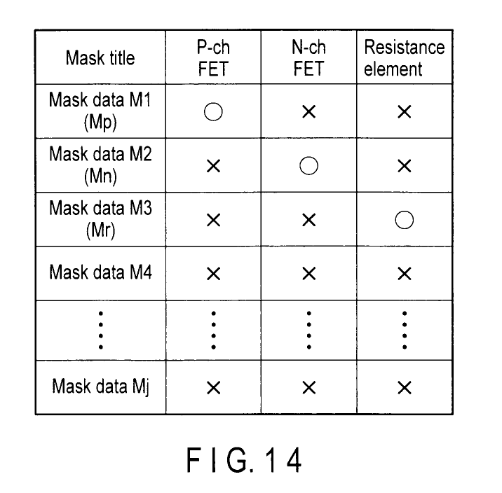

FIG. 10 illustrates an example of the layout (design data) of resistance elements. AA indicates an active area; and Mr, mask data. The mask data Mr shows an area (ion implantation area) to be actually subjected to P- or N-impurity ion implantation when manufacturing a semiconductor device. That is, as shown in FIG. 11, ion implantation to form the resistance elements is performed for the ion implantation area shown by the mask data Mr using the resist mask RM as a mask. Referring to FIG. 11, superscripts (+ and −) of P and N represent the resistance values (+→low resistance, −→high resistance) of the resistance elements.

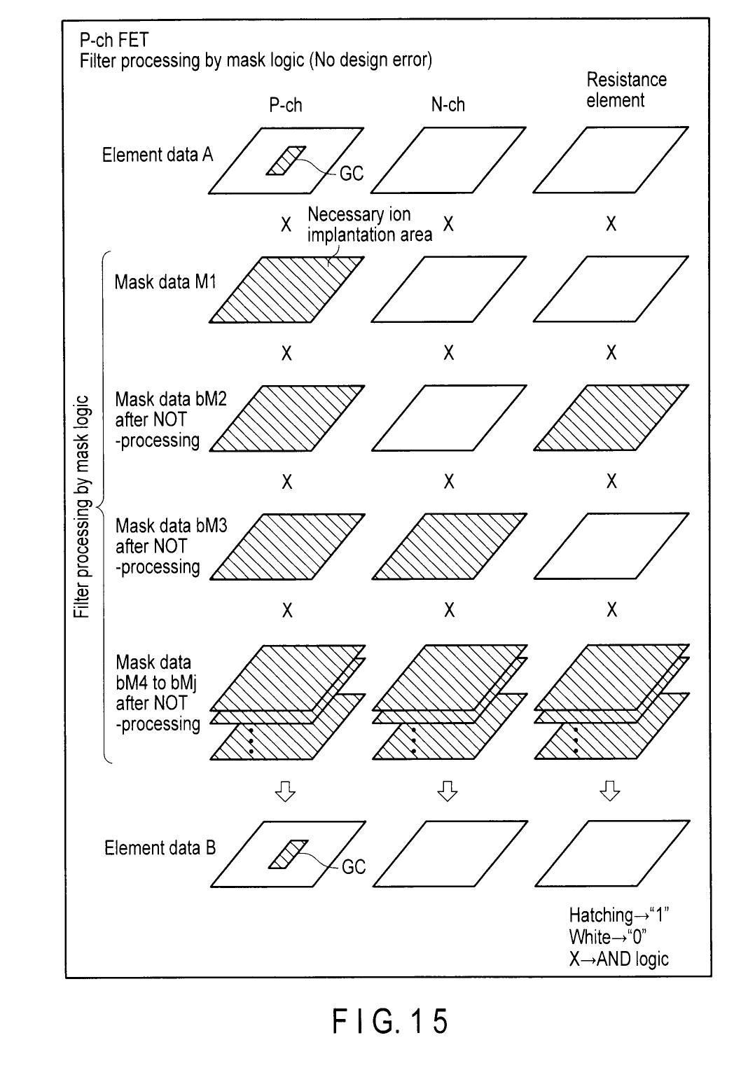

FIG. 12 shows an example of element extraction in the first verification step.

First, the active areas AA and the gates GC are extracted from the semiconductor integrated circuit (design data), and the logical AND between them is executed. As a result, the gate of a P-channel FET and that of an N-channel FET are extracted. In addition, the active AA and a resistance element R are extracted from the semiconductor integrated circuit, and the logical AND between them is executed. As a result, the resistance element R is extracted. The diffusion layer of the P-channel FET or that of the N-channel FET can also be extracted by the same logic method.

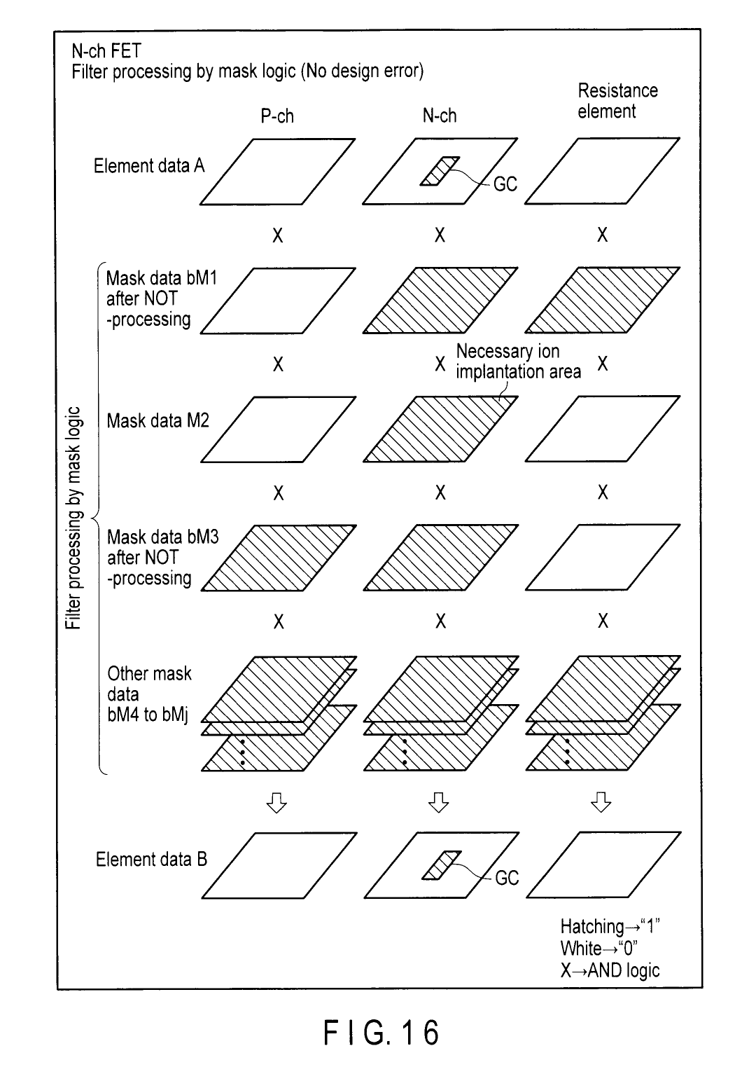

FIG. 13 shows NOT-processing of mask data.

Mask data M1 is the mask data Mp necessary in order to form the P-channel FET. The ion implantation area necessary for the P-channel FET is represented by, for example, data “1”. The mask data M1 after NOT-processing has data “1” in an area other than the ion implantation area necessary for the P-channel FET, as shown in FIG. 13.

Mask data M2 is the mask data Mn necessary in order to form the N-channel FET. The ion implantation area necessary for the N-channel FET is represented by, for example, data “1”. The mask data M2 after NOT-processing has data “1” in an area other than the ion implantation area necessary for the N-channel FET, as shown in FIG. 13.

Mask data M3 is the mask data Mr necessary in order to form the resistance element. The ion implantation area necessary for the resistance element is represented by, for example, data “1”. The mask data M3 after NOT-processing has data “1” in an area other than the ion implantation area necessary for the resistance element, as shown in FIG. 13.

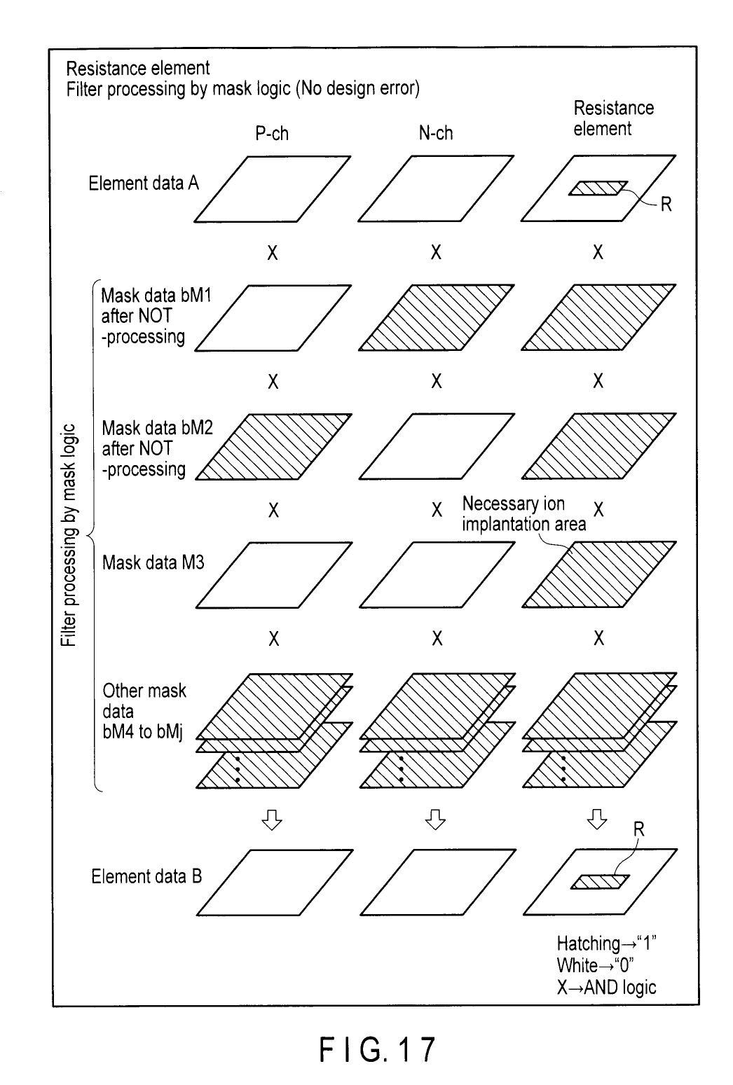

FIG. 14 shows an example of the relationship between verification target elements and mask data necessary in order to form them.

For example, assume that mask data necessary in order to form the P-channel FET is the mask data M1 (Mp), and the remaining mask data M2 to Mj are unnecessary in order to form the P-channel FET. Additionally, assume that mask data necessary in order to form the N-channel FET is the mask data M2 (Mn), and the remaining mask data M1 and M3 to Mj are unnecessary in order to form the N-channel FET. Furthermore, assume that mask data necessary in order to form the resistance element is the mask data M3 (Mr), and the remaining mask data M1, M2, and M4 to Mj are unnecessary in order to form the resistance element.

Under these assumptions, filter processing by mask logic is executed for the verification target elements extracted from the semiconductor integrated circuit.

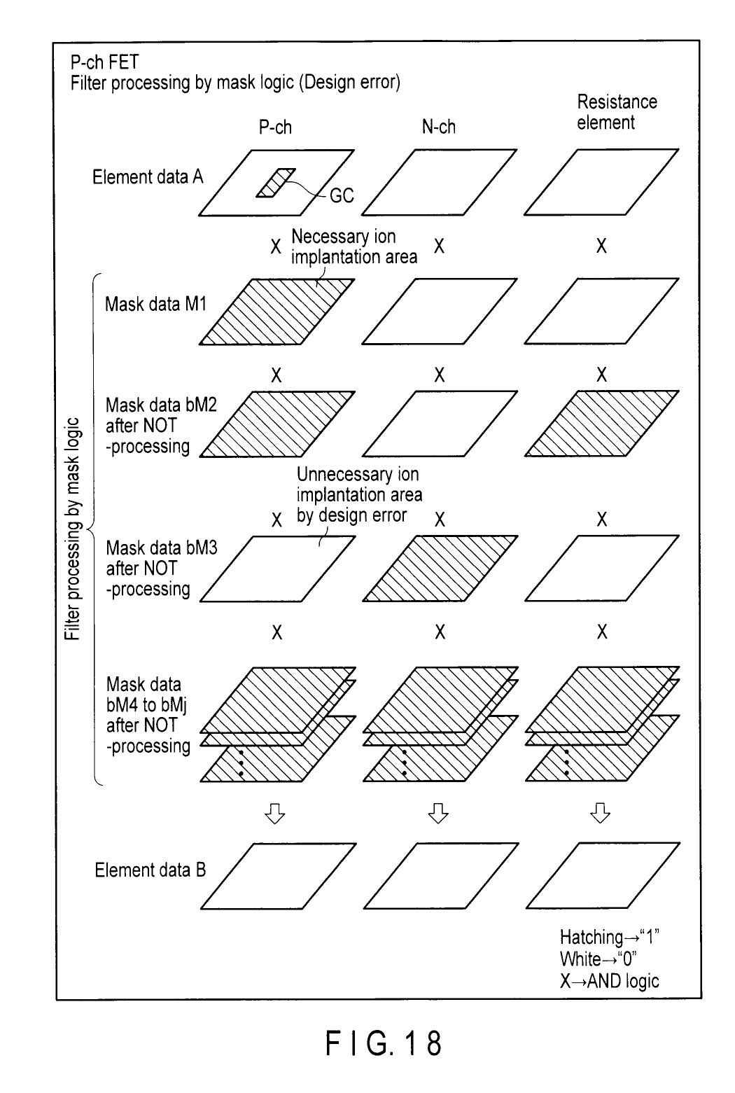

FIG. 15 shows filter processing of the P-channel FET without any design error.

Element data A represents the verification target element extracted by the element extraction step in FIG. 12.

The filter processing target is the gate GC of the P-channel FET. Hence, the logical AND is performed between the mask data M1 necessary in order to form the gate GC of the P-channel FET and data bM2 to bMj executing NOT-processing of mask data unnecessary in order to form the gate GC of the P-channel FET.

In this case, as shown in FIG. 15, the gate GC of the P-channel FET (element data A) before execution of the logical AND and that (element data B) after execution of the logical AND are identical (a state in which the verification target element is recognized).

Hence, when filter processing by mask logic is performed, and comparison verification of the circuit (comparison between the extracted element and the circuit diagram) in the first verification step (LVS) is performed successively, the presence/absence of an unnecessary/necessary ion implantation area can be verified.

For example, if no unnecessary ion implantation area exists/a necessary ion implantation area exists for the gate GC of the P-channel FET, the gate GC of the P-channel FET (element data B) remains after filter processing by mask logic. Hence, comparison verification of the circuit in the first verification step (LVS) is OK.

To the contrary, if an unnecessary ion implantation area exists/no necessary ion implantation area exists for the gate GC of the P-channel FET, the gate GC of the P-channel FET (element data B) disappears after filter processing by mask logic. Hence, comparison verification of the circuit in the first verification step (LVS) is NG.

FIG. 16 shows filter processing of the N-channel FET without any design error.

Element data A represents the gate GC of the N-channel FET extracted by the element extraction step in FIG. 12. In this example, the logical AND is performed between the mask data M2 necessary in order to form the gate GC of the N-channel FET and data bM1 and bM3 to bMj executing NOT-processing of mask data unnecessary in order to form the gate GC of the N-channel FET.

In this case, as shown in FIG. 16, the gate GC of the N-channel FET (element data A) before execution of the logical AND and that (element data B) after execution of the logical AND are identical (a state in which the verification target element is recognized).

Hence, when filter processing by mask logic is performed, and comparison verification of the circuit (comparison between the extracted element and the circuit diagram) in the first verification step (LVS) is performed successively, the presence/absence of an unnecessary/necessary ion implantation area can be verified.

For example, if no unnecessary ion implantation area exists/a necessary ion implantation area exists for the gate GC of the N-channel FET, the gate GC of the N-channel FET (element data B) remains after filter processing by mask logic. Hence, comparison verification of the circuit in the first verification step (LVS) is OK.

To the contrary, if an unnecessary ion implantation area exists/no necessary ion implantation area exists for the gate GC of the N-channel FET, the gate GC of the N-channel FET (element data B) disappears after filter processing by mask logic. Hence, comparison verification of the circuit in the first verification step (LVS) is NG.

FIG. 17 shows filter processing of the resistance element without any design error.

Element data A represents the resistance element R extracted by the element extraction step in FIG. 12. In this example, the logical AND is performed between the mask data M3 necessary in order to form the resistance element R and the data bM1, bM2, and bM4 to bMj executing NOT-processing of mask data unnecessary in order to form the resistance element R.

In this case, as shown in FIG. 17, the resistance element R (element data A) before execution of the logical AND and that (element data B) after execution of the logical AND are identical (a state in which the verification target element is recognized).

Hence, when filter processing by mask logic is performed, and comparison verification of the circuit (comparison between the extracted element and the circuit diagram) in the first verification step (LVS) is performed successively, the presence/absence of an unnecessary/necessary ion implantation area can be verified.

For example, if no unnecessary ion implantation area exists/a necessary ion implantation area exists for the resistance element R, the resistance element R (element data B) remains after filter processing by mask logic. Hence, comparison verification of the circuit in the first verification step (LVS) is OK.

To the contrary, if an unnecessary ion implantation area exists/no necessary ion implantation area exists for the resistance element R, the resistance element R (element data B) disappears after filter processing by mask logic. Hence, comparison verification of the circuit in the first verification step (LVS) is NG.

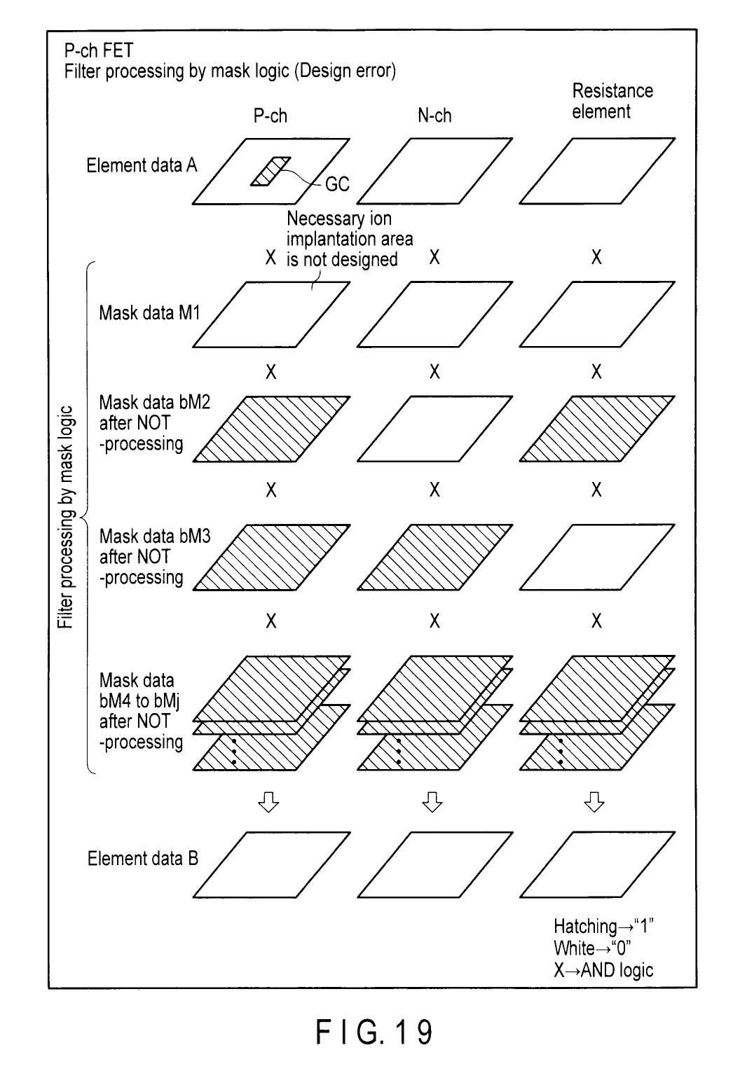

FIG. 18 shows filter processing of the P-channel FET with a design error.

Element data A represents the verification target element extracted by the element extraction step in FIG. 12.

The filter processing target is the gate GC of the P-channel FET. Hence, the logical AND is performed between the mask data M1 necessary in order to form the gate GC of the P-channel FET and the data bM2 to bMj executing NOT-processing of mask data unnecessary in order to form the gate GC of the P-channel FET.

In this example, a case will be explained in which mask data unnecessary in order to form the gate GC of the P-channel FET, that is, the data bM3 executing NOT-processing of the mask data includes an unnecessary ion implantation area, and unnecessary ion implantation is performed for the gate GC of the P-channel FET by the unnecessary ion implantation area.

In this case, as shown in FIG. 18, when the above-described logical AND is executed, the gate GC of the P-channel FET disappears. For this reason, the gate GC of the P-channel FET (element data A) before execution of the logical AND and that (element data B) after execution of the logical AND are different (a state in which the verification target element is not recognized).

Hence, when filter processing by mask logic is performed, and comparison verification of the circuit (comparison between the extracted element and the circuit diagram) in the first verification step (LVS) is performed successively, the presence of the unnecessary ion implantation area can be confirmed in the comparison verification.

That is, if an unnecessary ion implantation area exists for the gate GC of the P-channel FET, the gate GC of the P-channel FET (element data B) disappears after filter processing by mask logic. Hence, comparison verification of the circuit in the first verification step (LVS) is NG.

FIG. 19 shows filter processing of the P-channel FET with a design error.

According to the filter processing by mask data of this embodiment, an unnecessary ion implantation area can be detected. In addition, a design error corresponding to the absence of a necessary ion implantation area can be detected. This will be described below.

The mask data M1 originally includes an ion implantation area necessary in order to form the gate GC of the P-channel FET (see FIG. 15). A case in which the mask data M1 includes no necessary ion implantation area for forming the gate GC of the P-channel FET due to, for example, a design error will be examined.

Element data A represents the gate GC of the P-channel FET extracted by the element extraction step in FIG. 12. In this example, the logical AND is performed between the mask data M1 necessary in order to form the gate GC of the P-channel FET and the data bM2 to bMj executing NOT-processing of mask data unnecessary in order to form the gate GC of the P-channel FET.

In this case, the mask data M1 corresponding to the gate GC of the P-channel FET is data “0” because it includes no necessary ion implantation area. For this reason, when the above-described logical AND is executed, the gate GC of the P-channel FET disappears. Hence, the gate GC of the P-channel FET (element data A) before execution of the logical AND and that (element data B) after execution of the logical AND are different (a state in which the verification target element is not recognized).

Hence, when filter processing by mask logic is performed, and comparison verification of the circuit (comparison between the extracted element and the circuit diagram) in the first verification step (LVS) is performed successively, the absence of the necessary ion implantation area can be confirmed in the comparison verification.

That is, if no necessary ion implantation area exists for the gate GC of the P-channel FET, the gate GC of the P-channel FET (element data B) disappears after filter processing by mask logic. Hence, comparison verification of the circuit in the first verification step (LVS) is NG.

As described above, in the first embodiment, the first verification section (first verification step) performs filter processing by mask data. Comparison verification by the LVS step is thus performed for, for example, a verification target element that has undergone the filter processing. This makes it possible to verify whether elements extracted from design data and connections between them match a circuit diagram and simultaneously whether an unnecessary/necessary ion implantation area exists for the verification target element.

The filter processing of this example equally uses all mask data to be used to manufacture the semiconductor integrated circuit independently of the type of the verification target element. Hence, it is unnecessary to specify mask data in which an unnecessary ion implantation area exists/no necessary ion implantation area exists before verification by the first verification section. That is, it is possible to detect the presence/absence of an unnecessary/necessary ion implantation area only by classifying all mask data to be used to manufacture the semiconductor integrated circuit into mask data necessary in order to form the verification target element and mask data unnecessary in order to form the verification target element.

In addition, if a verification target element for which an unnecessary ion implantation area exists/no necessary ion implantation area exists is specified after verification by the first verification section, mask data (design error) including an unnecessary ion implantation area/no necessary ion implantation area for the verification target element can easily be specified. It is therefore possible to quickly and reliably correct the design error and shorten the design time.

Note that in the first embodiment, the filter processing step by mask data is added newly as one function of the first verification section 60 in FIG. 1. However, it may be added newly as one function of the second verification section 70 in FIG. 1.

When verifying the presence/absence of an unnecessary/necessary ion implantation area in the second verification step (DRC) by the second verification section 70, there is no step like the circuit comparison verification step in the first verification step (LVS). Hence, the following comparison verification step can be added for element data B shown in FIGS. 15, 16, 17, 18, and 19.

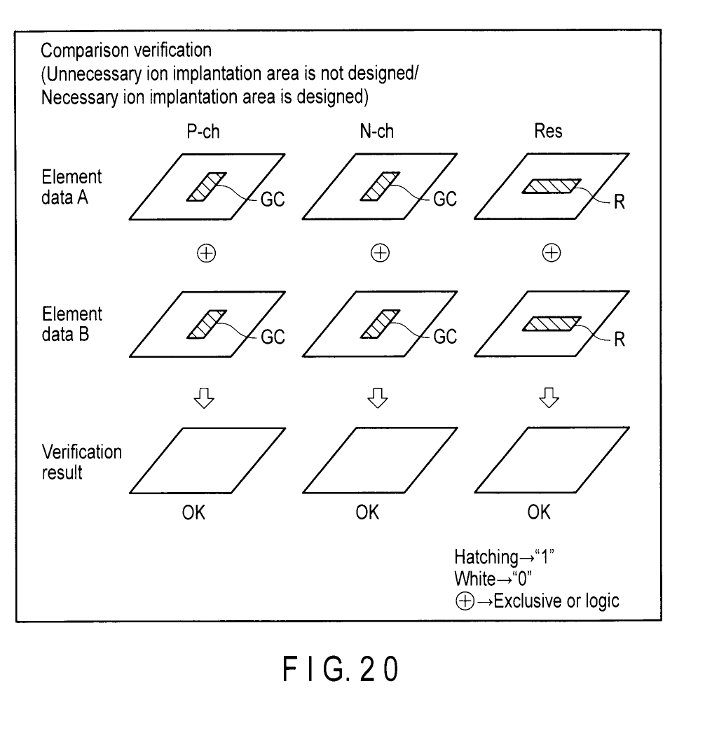

For example, as shown in FIG. 20, the logical exclusive OR (XOR) between element data A and element data B is executed. If no unnecessary ion implantation area exists/a necessary ion implantation area exists, the extracted element (verification target element) disappears as the verification result. The state in which the verification target element disappears represents that the verification result is OK, that is, the absence of an unnecessary ion implantation area/the presence of a necessary ion implantation area for the verification target element.

On the other hand, for example, when the logical exclusive OR (XOR) between element data A and element data B is executed in case of the presence of an unnecessary ion implantation area/the absence of a necessary ion implantation area, as shown in FIG. 21, the extracted element (verification target element) remains. The state in which the verification target element remains represents that the verification result is NG, that is, the presence of an unnecessary ion implantation area/the absence of a necessary ion implantation area for the verification target element.

### (2) Second Embodiment

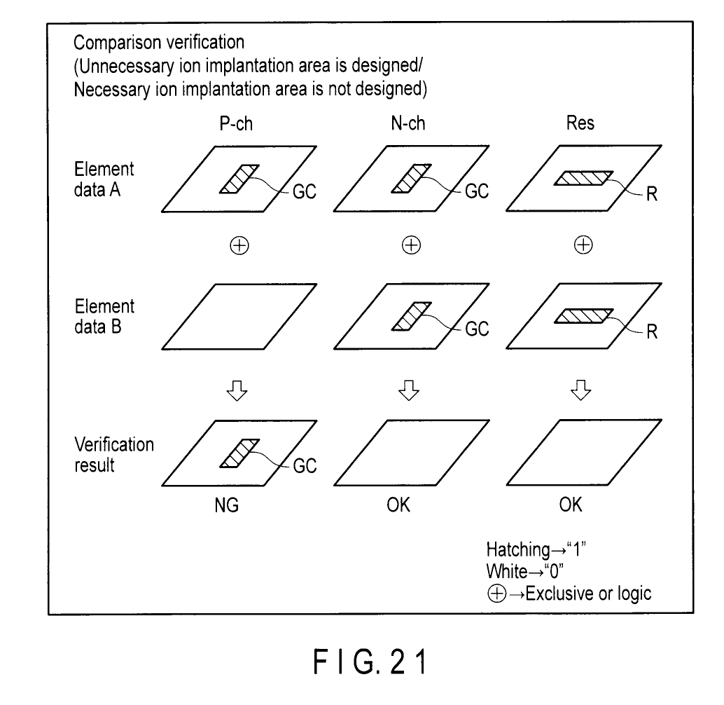

In the second embodiment, as shown in FIG. 22, the filter processing step by mask data is newly added as a third verification section (filter processing section) 80 in a layout verification section 50 independently of a first verification section 60 and a second verification section 70. The remaining components are the same as in the first embodiment, and a description thereof will not be repeated.

First, a design section 30 designs a circuit diagram based on specification information (design step). Next, a layout creation section 40 creates the layout (design data) of a semiconductor integrated circuit based on the circuit diagram (layout creation step).

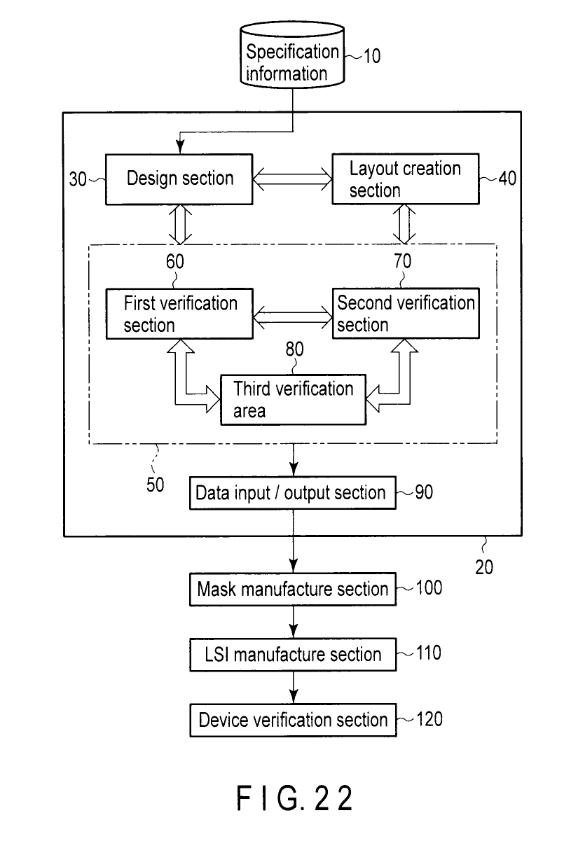

After that, layout check is performed in accordance with the flowchart of FIG. 23 to verify whether the layout of the semiconductor integrated circuit has been designed correctly.

First, a first verification step (LVS) is executed to verify based on the DRC-rule, the LVS-rule, and the design rule whether elements extracted from the design data and connections between them match the circuit diagram. In addition, a second verification step (DRC) is executed to verify whether the design data violates the design rule extracted from the specification information (step ST1).

After that, LVS/DRC verification is performed (step ST2).

Upon detecting an error in this verification, the designer corrects the layout based on the error information. The design data correction and layout check are repeated until the layout check is passed.

When the first and second verification steps are passed, the third verification step is performed next. In the third verification step, it is verified whether an unnecessary/necessary ion implantation area exists. First, design data is read (step ST3). Then, the filter processing step by mask data is executed (step ST4).

After that, the layout of the semiconductor integrated circuit is verified (step ST5).

Upon detecting an error in this verification, the designer corrects the layout based on the error information. The design data correction and layout check are repeated until the layout check is passed.

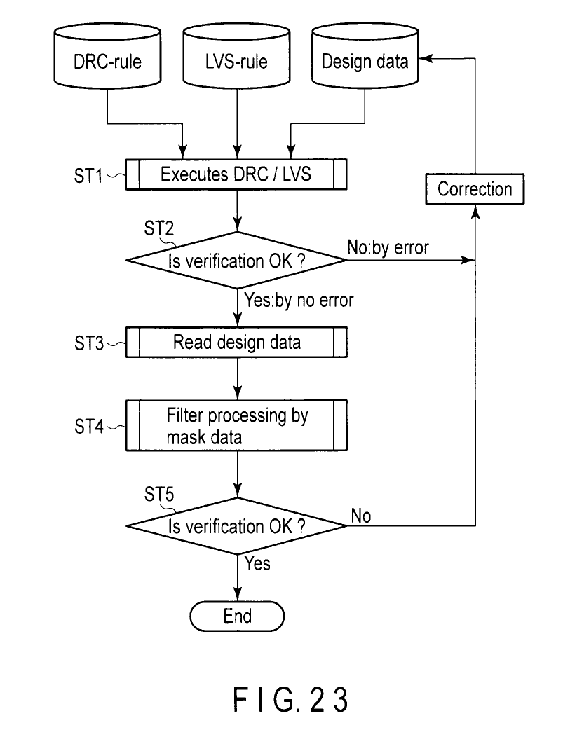

The filter processing step is performed as parallel processing for a plurality of verification target elements of identical type (for example, one of the gate and source/drain of a FET, a resistance element, a capacitance element, and a rectifying element) extracted from the semiconductor integrated circuit, as shown in the flowchart of FIG. 24. Together with this parallel processing, parallel processing may be performed for a plurality of verification target elements of different types extracted from the semiconductor integrated circuit, as shown in the flowchart of FIG. 26.

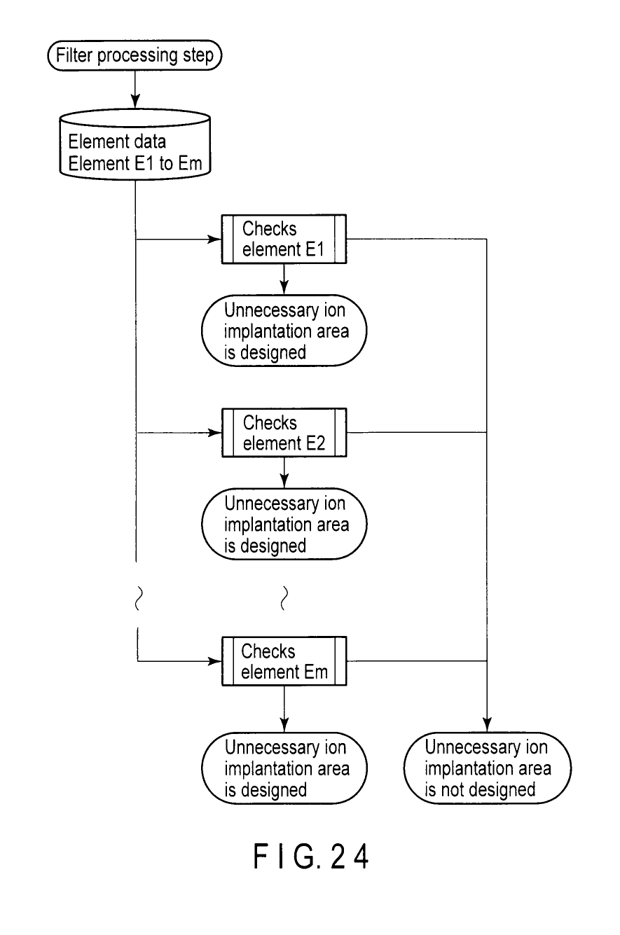

More specifically, the filter processing step includes a first logic step (step ST1) of executing a logical AND between a verification target element (element data) Ei(i=1, 2, . . . , m), mask data necessary in order to form the verification target element Ei, and data executing NOT-processing of mask data unnecessary in order to form the verification target element Ei (inverted data of mask data unnecessary in order to form the verification target element Ei), and a second logic step (steps ST2 and ST3) of determining the presence/absence of an unnecessary ion implantation area for the verification target element Ei by a logical exclusive OR (XOR) between the verification target element Ei before execution of the first logic step and that after execution of the first logic step, as shown in the flowchart of FIG. 25.

The filter processing step is the same as in the first embodiment (FIGS. 6, 7, 8, 9, 10, 11, 12, 13, 14, 15, 16, 17, 18, 19, 20, and 21). A detailed description of this step has already been done in the first embodiment and will not be repeated here.

The second embodiment is different from the first embodiment in that the step of executing the logical exclusive OR (XOR) is added.

In the first embodiment, for example, circuit comparison is done in the first verification step (LVS). Hence, the logical exclusive OR is unnecessary. In the second embodiment, however, the presence/absence of an unnecessary/necessary ion implantation area is verified in the third verification step independently of the first and second verification steps. To do this, the logical exclusive OR is preferably provided.

Comparison verification by the logical exclusive OR is performed as shown in, for example, FIGS. 20 and 21.

First, as shown in FIG. 20, when the logical exclusive OR between element data A and element data B is executed in case of the absence of an unnecessary ion implantation area/the presence of a necessary ion implantation area, the extracted element (verification target element) disappears as the verification result. The state in which the verification target element disappears represents that the verification result is OK, that is, the absence of an unnecessary ion implantation area/the presence of a necessary ion implantation area for the verification target element.

In addition, when the logical exclusive OR between element data A and element data B is executed in case of the presence of an unnecessary ion implantation area/the absence of a necessary ion implantation area, as shown in FIG. 21, the extracted element (verification target element) remains. The state in which the verification target element remains represents that the verification result is NG, that is, the presence of an unnecessary ion implantation area/the absence of a necessary ion implantation area for the verification target element.

This filter processing step enables to detect the presence/absence of an unnecessary/necessary ion implantation area for the verification target element Ei.

According to the second embodiment as well, the same effects as in the first embodiment can be obtained.

### 3. CONCLUSION

According to the embodiments, it is possible to automatically verify by layout check in the design stage whether ion implantation is appropriately performed for an element that requires ion implantation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A layout verification apparatus of a semiconductor integrated circuit, the apparatus comprising:
a design section configured to design a circuit diagram based on specification information;
a layout creation section configured to create a layout of a semiconductor integrated circuit based on the circuit diagram;
a first verification section configured to verify whether an element extracted from the layout of the semiconductor integrated circuit matches the circuit diagram; and
a second verification section configured to verify whether the layout of the semiconductor integrated circuit matches a design rule extracted from the specification information,
wherein one of the first and second verification sections includes a filter processing section which applies a mask data used to a manufacture of the semiconductor integrated circuit to the verification target element which needs an ion implantation,
wherein the filter processing section comprises a first logic section which executes an logical AND of the verification target element to be verified, a mask data necessary in order to form the verification target element to be verified, and a data inverted a mask data unnecessary in order to form the verification target element to be verified.

2. The apparatus of claim 1, wherein when the first verification section comprises the filter processing section, the first verification section performs comparison verification to verify whether the verification target element after the filter processing matches the circuit diagram.

3. The apparatus of claim 1, wherein when the second verification section comprises the filter processing section, the filter processing section further comprises a second logic section configured to execute a logical exclusive OR between the verification target element before execution of the logical AND and the verification target element after execution of the logical AND.

4. The apparatus of claim 1, wherein the filter processing section determines simultaneously for a plurality of verification target elements of different types extracted from the semiconductor integrated circuit whether the ion implantation is appropriately performed.

5. The apparatus of claim 1, wherein the verification target element is one of a gate and source/drain of a FET, a resistance element, a capacitance element, and a rectifying element.

6. A layout verification apparatus of a semiconductor integrated circuit, the apparatus comprising:
a design section configured to design a circuit diagram based on specification information;
a layout creation section configured to create a layout of a semiconductor integrated circuit based on the circuit diagram;
a first verification section configured to verify whether an element extracted from the layout of the semiconductor integrated circuit matches the circuit diagram;
a second verification section configured to verify whether the layout of the semiconductor integrated circuit matches a design rule extracted from the specification information; and
a filter processing section configured to apply a mask data used to a manufacture of the semiconductor integrated circuit to the verification target element which needs an ion implantation,
wherein the filter processing section comprises a first logic section and a second logic section,
the first logic section executes an logical AND of the verification target element to be verified, a mask data necessary in order to form the verification target element to be verified, and a data inverted a mask data unnecessary in order to form the verification target element to be verified, and
the second logic section executes a logical exclusive OR between the verification target element before execution of the logical AND and the verification target element after execution of the logical AND.

7. The apparatus of claim 6, wherein the filter processing section determines simultaneously for a plurality of verification target elements of different types extracted from the semiconductor integrated circuit whether the ion implantation is appropriately performed.

8. The apparatus of claim 6, wherein the verification target element is one of a gate and source/drain of a FET, a resistance element, a capacitance element, and a rectifying element.

9. A layout verification method of a semiconductor integrated circuit, the method comprising:
designing a circuit diagram based on specification information;
creating a layout of a semiconductor integrated circuit based on the circuit diagram;
executing first verification to verify whether an element extracted from the layout of the semiconductor integrated circuit matches the circuit diagram; and
executing second verification to verify whether the layout of the semiconductor integrated circuit matches a design rule extracted from the specification information,
wherein one of the first and second verification includes a filter processing which applies a mask data used to a manufacture of the semiconductor integrated circuit to the verification target element which needs an ion implantation,
wherein the filter processing executes an logical AND of the verification target element to be verified, a mask data necessary in order to form the verification target element to be verified, and a data inverted a mask data unnecessary in order to form the verification target element to be verified.

10. The method of claim 9, wherein when the first verification includes the filter processing, comparison verification to verify whether the verification target element after the filter processing matches the circuit diagram is performed in the first verification.

11. The method of claim 9, wherein when the second verification includes the filter processing, a logical exclusive OR between the verification target element before execution of the logical AND and the verification target element after execution of the logical AND is further executed in the filter processing.

12. The method of claim 9, wherein in the filter processing, it is determined simultaneously for a plurality of verification target elements of different types extracted from the semiconductor integrated circuit whether the ion implantation is appropriately performed.

13. The method of claim 9, wherein the verification target element is one of a gate and source/drain of a FET, a resistance element, a capacitance element, and a rectifying element.

14. A layout verification method of a semiconductor integrated circuit, the method comprising:
designing a circuit diagram based on specification information;
creating a layout of a semiconductor integrated circuit based on the circuit diagram;
verifying whether an element extracted from the layout of the semiconductor integrated circuit matches the circuit diagram;
verifying whether the layout of the semiconductor integrated circuit matches a design rule extracted from the specification information; and
applying, for a verification target element which needs an ion implantation, filter processing by mask data to be used to a manufacture of the semiconductor integrated circuit,
wherein the filter processing comprises a first logic and a second logic,
the first logic executes an logical AND of the verification target element to be verified, a mask data necessary in order to form the verification target element to be verified, and a data inverted a mask data unnecessary in order to form the verification target element to be verified, and
the second logic executes a logical exclusive OR between the verification target element before execution of the logical AND and the verification target element after execution of the logical AND.

15. The method of claim 14, wherein in the filter processing, it is determined simultaneously for a plurality of verification target elements of different types extracted from the semiconductor integrated circuit whether the ion implantation is appropriately performed.

16. The method of claim 14, wherein the verification target element is one of a gate and source/drain of a FET, a resistance element, a capacitance element, and a rectifying element.
